(19) United States
(12) Patent Application Publication
(10) Pub. No.: US 2009/0028115 A1
(43) Pub. Date: Jan. 29, 2009

(54) HYBRID WLAN-GSM DEVICE SYNCHRONIZATION TO ELIMINATE NEED FOR COSTLY FILTERS

(75) Inventor: Olaf Hirsch, Sunnyvale, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/278,049

(22) PCT Filed: Feb. 3, 2007
(86) PCT No.: PCT/IB07/50365

§ 371 Date: Aug. 6, 2008

(30) Foreign Application Priority Data
Feb. 3, 2007 (IB) PCT/IB2007/050365

(51) Int. Cl. H04B 7/212; H04J 3/00; G06Q 10/00; G06Q 50/00

(52) U.S. Cl. 370/337; 370/336; 705/7

(57) ABSTRACT

A multi-mode WLAN-GSM communications device (100) comprises a WLAN transmitter (110) that stalls its transmit data and depowers its radio transmitter whenever a collocated GSM receiver (104) signals it needs to receive a GSM base-station transmission. If a collocated Bluetooth device is also included, the Bluetooth receiver can also signal the WLAN transmitter (110) to be quiet during selected timeslots.

The present invention relates to multi-mode GSM-WLAN phones, and more particularly to methods and equipment to reduce the manufacturing costs of circuits to control co-interference

Multimode portable electronic devices are being introduced that were never contemplated by the standards bodies that gave birth to their constituent parts. Combinations like global system for mobile communications (GSM) mobile phones, and wireless local area network (WLAN), to provide telephone service are very useful, but the wireless modes they use can cause mutual interference. Wideband noise generated by a WLAN transmitter can reduce the sensitivity of the cellular phone receiver. In conventional designs, a specialized filter is needed between the antenna and WLAN transceiver to mitigate the problem. Such filters are relatively expensive, bulky, and reduce the WLAN's output power and input sensitivity.

Multimode GSM mobile phones are now able to dynamically support telephone connections via (voice over Internet) VoIP and WLAN connections to save money and/or to improve connection quality. IEEE-802.11b/g type WLAN's use the 2.4-GHz unlicensed radio spectrum, while IEEE-802.11a type WLAN's use the twenty-three orthogonal frequency division multiplexing (OFDM) channels in the 5-GHz band set aside for them. Bluetooth communications can interfere with the 802.11b/g WLAN's using the 2.4-GHz band, and the third harmonics of some GSM channels can interfere with particular OFDM sub-carrier frequencies in the 5-GHz IEEE-802.11a WLAN channels.

Isolation and shielding between collocated radios is an effective way to reduce co-interference. But, the small form factors and finite isolation effects afforded by antenna orientation and layout limit how practical such isolation and shielding can be. Better filtering on the transmitter outputs helps a lot, but such also increases device size and cost. Extra filtering can unfortunately reduce transmitter efficiency and linearity. Cross-modulation components can be reduced by increasing the transmitter linearity, but at the cost of efficiency. However, battery powered portable devices have to be very efficient in their use of power.

Quorum Systems (San Diego, Calif.) says its multi-mode intellectual property (IP) is the first commercial technology to support GSM voice calls and WLAN Internet connections simultaneously using a single radio device. Combining WLAN and GSM allows cellular subscribers to send e-mail, download maps, look at photos and video, and make GSM calls. The GSM's SIM card technology allows WLAN devices to securely roam between hotspots and cells. WLAN's widespread use in homes and enterprises increases phone coverage by using VoIP and SIM card technology to allow GSM hand-offs to WLAN hotspots. The Quorum multi-mode technology provides for GSM and WLAN to share a single multi-mode radio by time slicing the radio so that GSM and WLAN can both maintain connections. Sharing a radio allows the design to be simplified and the bill-of-materials to be reduced.

Quorum Systems (San Diego, Calif.) markets the Sereno QS2000, a single-chip CMOS transceiver that integrates 802.11b/g and GSM/GPRS/EDGE. It enables simultaneous voice and data operation and seamless hand-off. The device uses a scheduling scheme for pseudo-simultaneous operation of wireless and cellular radios that eliminates the need for expensive RF isolation and shielding techniques that have been conventional.

The Quorum Connection (QC) 2530 is a highly integrated radio frequency (RF) transceiver that is able to support both wireless local area network (WLAN) and Quad Band GSM cellular applications simultaneously. The QC2530 combines 802.11b/g WLAN and cellular GSM/GPRS/EDGE technologies in a single die. It uses Quorum's so-called Multi-Access Technology (QMAT), which allows the radio resource to be shared, enabling multi-mode functionality while reusing passive and silicon real estate. Also as a result of the QMAT technology, interference, which previously led to expensive handsets and the delayed adoption of multi-mode radio band technology in handhelds, has been eliminated in the QC2530 multi-mode single-chip transceiver.

In order to deal with interference, several multi-mode devices try reducing the output power levels for both the GSM and WLAN radios. But these measures can increase the cost and the size, and reduce the range. Increased front-end filtering improves selectivity at a price, and increasing the physical separation between the WLAN and GSM antennas reduces coupling but makes the device larger.

Some prior art multi-mode GSM/WLAN systems depend on non-simultaneous operation. The WLAN transmitter is turned off whenever the GSM radio is active. Whenever a GSM transmission interferes with the reception of a WLAN transmission, the WLAN subsystem waits for the WLAN access point to automatically retransmit the packet. What results is a need for some type of traffic management, or scheduling within the multi-mode solution. This scheduling is often implemented within the application software or top-level baseband protocol stacks. The result is a functional multi-mode solution, but only one mode is active at any one time. One chip maker has developed multi-mode intellectual property (IP) that implements the needed scheduling. GSM transmissions and receptions are synchronized with those of the collocated WLAN. A single radio chain can be used for a multi-mode solution. This allows for a simple architecture, and it reduces the overall time-averaged power consumption of the multi-mode handset.

To avoid desensitizing the GSM receiver, the IP schedules WLAN transmission for periods when GSM will not need the radio channel. The scheduling algorithms synchronize their access point transmissions to GSM radio activity. Such technology just about eliminates the interference between WLAN and GSM subsystems.

Quorom Systems (San Diego, Calif.) markets a single chip IC for multi-mode wireless (WiFi and GSM). The new technology provides wireless voice-over-IP (VoIP) connectivity and seamless voice roaming across WiFi and cellular networks. The Quorum Connection (QC) 2530 is an integrated radio frequency (RF) transceiver for both wireless local area network (WLAN) and Quad Band GSM cellular applications simultaneously. Handsets built around the QC2530 provide a seamless user experience across WiFi and cellular service. The technique can offload capacity in peak periods and in congested areas like airports and convention centers. It can extend the reach of cellular networks to homes and within office building using Voice-over-WLAN, and provide data services via WiFi hot-spots.

Briefly, a multi-mode WLAN-GSM communications device embodiment of the present invention comprises a WLAN transmitter that stalls its transmit data and depowers its radio transmitter whenever a collocated GSM receiver signals it needs to receive a GSM base-station transmission. If a collocated Bluetooth device is also included, the Bluetooth receiver can also signal the WLAN transmitter to be quiet during selected timeslots.

An advantage of the present invention is a dual-mode handset is provided that does not need an expensive filter to reject WLAN transmissions from the collocated GSM receiver.

A further advantage of the present invention is a dual-mode handset is provided that can be made smaller because bulky filters have been eliminated.

A still further advantage of the present invention is that a method is provided that can be used to improve GSM receiver sensitivity in dual-mode GSM and WLAN devices.

The above and still further objects, features, and advantages of the present invention will become apparent upon consideration of the following detailed description of specific embodiments thereof, especially when taken in conjunction with the accompanying drawings.

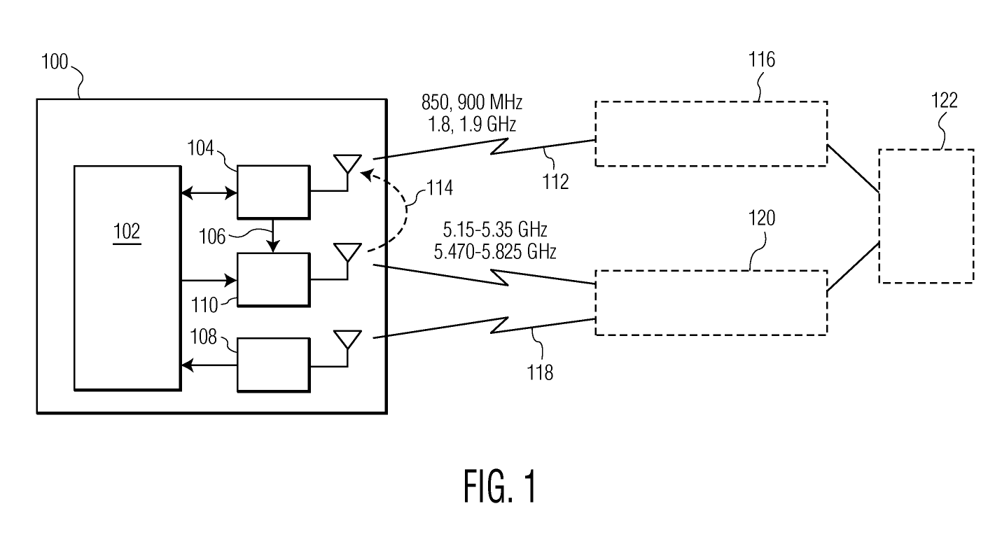

FIG. 1 is a functional block diagram of a dual-mode handset system embodiment of the present invention and a supporting cellular radio access network and unlicensed mobile access network;

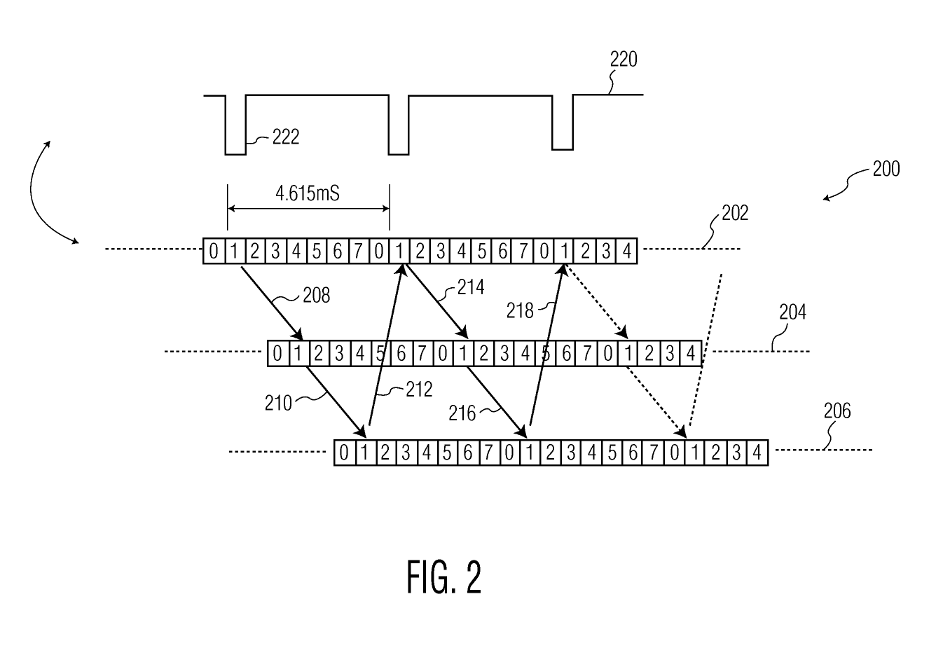

FIG. 2 is a timing diagram showing the relationships between GSM timeslots and a WLAN-TX enable signal used to quiet the WLAN transmitter whenever the GSM receiver needs to listen to a local base-station transmission;

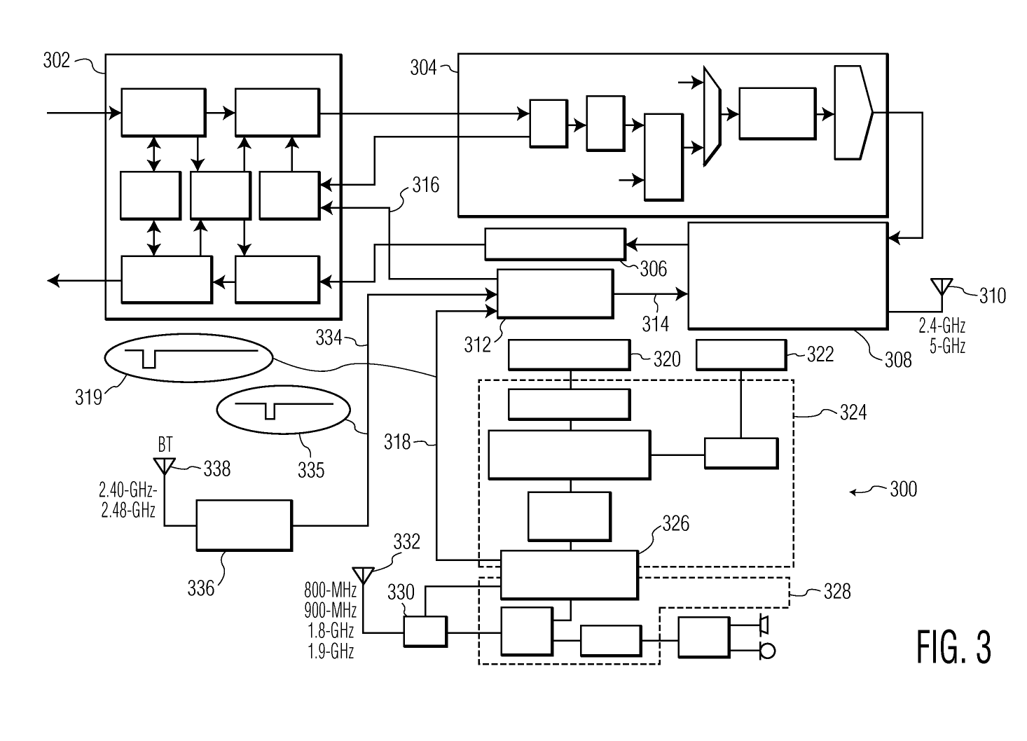

FIG. 3 is a functional block diagram of a multi-mode handset system embodiment of the present invention, and shows the GSM Layer-1 radio link control generation of a request to stall and quiet WLAN transmissions during particular timeslots; and

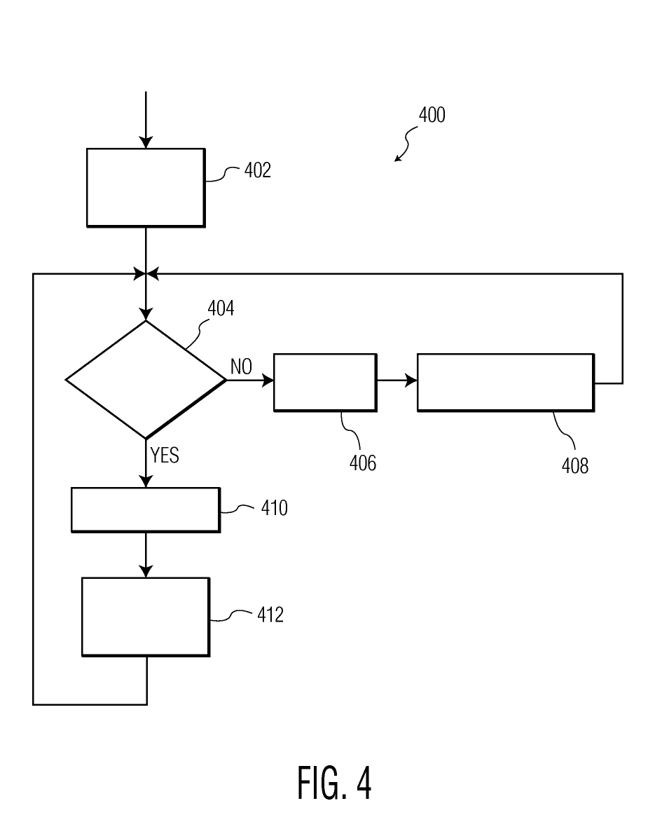

FIG. 4 is a flowchart diagram of a method embodiment of the present invention for eliminating an expensive filter between a WLAN transmitter and a collocated GSM receiver by allowing a GSM radio link control to stall and quiet WLAN transmissions during particular GSM receiver timeslots.

FIG. 1 represents a dual-mode handset system embodiment of the present invention, and is referred to herein by the general reference numeral 100. The dual-mode handset 100 comprises a mobile phone 102, a GSM sub-system 104, a GSM channel information link 106, a WLAN receiver (RX) 108, and a WLAN transmitter (TX) 110. The GSM sub-system 104 conventionally communicates cellular phone conversations over a GSM link 112 on the 850, 900, 1800, and/or 1900-MHz radio bands.

GSM airlink communication between the mobile handset and base-station (BTS) is supported by both a physical channel and several logical channels. The physical channel is defined by frequency as well as by time. Two frequencies support duplex communication between the mobile handset and the network, with eight repetitive time slot periods providing eight unique access points in time (577-μs slot duration) for an equal number of mobile handset units. This scheme is referred to as TDMA since data is sent in time-limited bursts under strict network control. One of these slots is used for a single mobile handset, leaving the potential for another seven mobile handsets to gain access to the network on the same frequency pair, each using different slot assignments. A typical session has the BTS transmit a burst to the mobile handset within one time slot, and then receives from the mobile handset a related burst three time slots later.

GSM systems use a discontinuous reception method to help power to be conserved at the mobile station. The paging channel used by the base station to signal an incoming call, is divided into sub-channels. Each mobile station listen only to its respective sub-channel. In the time between successive paging sub-channels, the mobile can go into a sleep mode where almost no power is used. All of this increases battery life considerably when compared to analog phones.

The GSM channel information link 106 provides a special signal to quiet the WLAN TX 110 when the receiver side in the GSM 104 needs to listen to transmissions 112 from the RAN 116. Such transmissions are predictable, and occur in regular bursts in particular timeslots. If the WLAN TX 110 were not quieted during these periods, an interference signal 114 would cause the GSM 104 to be desensitized. Without the present invention, a special and very expensive filter would otherwise be needed between WLAN TX 110 and its antenna, or GSM 104 and its antenna, to filter out signal 114.

Embodiments of the present invention are therefore critically characterized by a special timeslot synchronized blanking of the WLAN TX 110, by at least a collocated GSM receiver, to eliminate the need to install an expensive RF-filter unit between them. If a Bluetooth receiver is also collocated, its receiver too could issue blanking or power limiting signals to the WLAN TX 110 to allow Bluetooth reception during its respective timeslots. For example, see FIG. 3.

In FIG. 1, a cellular radio access network (RAN) 116 supports the GSM telephone calls. When in range, IEEE-802.11a communications 118 will be received from an unlicensed mobile access network (UMAN) 120. The UNII communications 118 typically operate in either of two bands, 2.4-GHz or 5-GHz, e.g., by Federal Communications Commission (FCC) regulation. A core mobile network 122 is able to maintain telephone communications with the dual-mode handset 100 through either the RAN 116 or the UMAN 120, depending on the user's relative positioning and service subscription.

Various products are commercially available now that can be used to implement dual-mode handset 100. Philips Electronics markets an unlicensed mobile access (UMA) semiconductor reference design for mobile handset manufacturers. A mobile phone's access of GSM and GPRS mobile services through traditional cellular networks can be automatically handed over to VoIP/WLAN access points. This gives mobile phone customers added flexibility for advanced phone services as their phones detect the fastest and most cost-effective network without interruptions. If a phone is taken out of the WLAN range, it seamlessly switches back to the cellular network.

UMA technology provides access, e.g., to GSM and GPRS mobile services over unlicensed spectrum technologies, including Bluetooth and 802.11. UMA technology allows subscribers to roam and handover between cellular networks and public and private unlicensed wireless networks using dual-mode mobile handsets. The Philips Nexperia™ Cellular System Solution 6120 supports a wide variety of multimedia applications and includes a GSM/GPRS/EDGE mobile platform, an RF baseband transceiver, a power amplifier, a power management unit, and a battery charger. Kineto UMA Client Software in the Nexperia 6120 System Solution enables mobile phones to roam seamlessly between mobile networks and WLAN's. Philips 802.11g WLAN SiP allows mobile phone users to access voice, data and multimedia services through WLAN networks up to five times faster than current 802.11b products, without compromising the battery life of mobile phones.

Referring again to FIG. 1, in one scenario, a mobile subscriber with a UMA-enabled, dual-mode handset 100 moves within range of an unlicensed wireless network 120 to which the handset is allowed to connect. Upon connecting, handset 100 logs into a UMA network controller (UNC) via UMAN 120. The handset can be authenticated and authorized to access GSM voice and GPRS data services via the unlicensed wireless network 120. If authorized, the subscriber's current location information stored in the core network is updated. All mobile voice and data traffic thereafter is routed to the handset via the UMAN 120 rather than the cellular RAN 116. When a UMA-enabled subscriber handset 100 moves outside the range of a particular UMAN 120, the UNC and handset facilitate roaming back to the licensed outdoor network, e.g., cellular RAN 116. Such roaming process is preferably seamless to the subscriber. If a subscriber is on an active GSM voice call, or GPRS data session when they cross within range of an unlicensed wireless network, the voice call or data session will automatically handover between access networks

The GSM radio frequency spectrum specified for GSM-900 system mobile radio networks uses one hundred twenty-four frequency channels each with a bandwidth of 200-KHz for both the uplink and downlink direction. The mobile station (MS) to base-station (BTS) uplink uses 890-MHz to 915-MHz, and the BTS to mobile station downlink uses 935-MHz to 960-MHz. The duplex spacing between the uplink and downlink channels is 45-MHz. The so-called E-GSM band adds fifty frequency channels and the R-GSM another twenty frequency channels to the spectrum.

FIG. 2 is a timing diagram 200 representing the eight time-division multiple access (TDMA) timeslots that occur in every GSM frame as seen at a mobile station (MS) like dual-mode handset 100. There are twenty six frames in a multi-frame with a 120-millisecond duration. The first twelve frames (0-11) are traffic channels (TCH), frame-12 is slow associated control channel (SACCH), frames 13-24 are TCH, and frame-25 is unused.

A series of GSM-RX TCH downlink timeslots 202 repeats every 4.615 (60/13) milliseconds. For example here in FIG. 1, this particular MS is operating on slot-1 for both downlink and uplink. A TCH uplink series of GSM-TX timeslots 204 is skewed a little later and it also repeats every 4.615 milliseconds. A GSM-monitor 206 is also being watched for broadcast control channel (BCCH) in time-slot-1. Each TCH is used to carry speech and data traffic. A burst period is defined as 120-milliseconds divided by twenty-six frames, divided by eight burst periods per frame.

The sequence of receiving timeslot-1 in GSM-RX 202, transmitting in timeslot-1 from GSM-TX 204, and checking timeslot-1 in GSM-monitor 206 is represented by steps 208, 210, 212. The cycle repeats with steps 214, 216, and 218. A WLAN-TX enable signal 220 is generated by the GSM receiver, and is represented by signal 106 in FIG. 1. A disable pulse 222 causes the WLAN-TX 110 to stall the transmit data and depower the WLAN radio transmitter power output amplifier. The WLAN receiver needs to remain connected to its antenna so it can continue the WLAN link 118. The disable pulse 222 will occur for every instance that it is important for the GSM receiver to receive a signal from its corresponding BTS. The GSM radio link control, Layer-1, is a likely place to generate such a control signal with a minimal impact to a preexisting conventional design.

As shown in FIG. 2, timeslot-1 TCH's for the uplink 204 and downlink 202 are separated in time, e.g., by three burst periods so the MS 102 does not have to transmit and receive simultaneously. Common channels can be accessed both by idle mode and dedicated mode mobiles. The common channels are used by idle mode mobiles to exchange the signaling information required to change to dedicated mode. Mobiles already in dedicated mode monitor the surrounding base stations for handover and other information. The common channels are defined within a 51-frame multi-frame, so that dedicated mobiles using the 26-frame multi-frame TCH structure can still monitor control channels. The common channels include the BCCH which continually broadcasts, on the downlink, information about the base station identity, frequency allocations, and frequency-hopping sequences. A frequency correction channel (FCCH) and synchronization channel (SCH) are used to synchronize the mobile to the time slot structure of a cell by defining the boundaries of burst periods, and the time slot numbering. Every cell in a GSM network broadcasts exactly one FCCH and one SCH, which are by definition on timeslot-0 within a TDMA frame. A random access channel (RACH) is a slotted aloha channel used by the mobile to request access to the network. A paging channel (PCH) is used to alert the mobile station of an incoming call. An access grant channel (AGCH) is used to allocate an SDCCH to a mobile for signaling in order to obtain a dedicated channel, following a request on the RACH.

There are four different types of bursts used for GSM transmission. A “normal” burst carries the data and does most of the signaling. It has a total length of 156.25 bits, is made up of two 57-bit information bits, a 26-bit training sequence used for equalization, one stealing bit for each information block (used for FACCH), three tail bits at each end, and an 8.25 bit guard sequence. The 156.25 bits are transmitted in 0.577 milliseconds, giving a gross bit rate of 270.833 kbps. An F-burst, used on the FCCH, and the S-burst, used on the SCH, have the same length as a normal burst, but a different internal structure. Such differentiates them from normal bursts for synchronization. An “access” burst is shorter than the normal burst, and is used only on the RACH.

In FIG. 1, signal 106 will be generated and issued to quiet transmissions from WLAN-TX 110 whenever the GSM-RX in the MS 100 needs to listen to the BTS transmissions. If the GSM is off, or inoperable for some reason, then only very few and infrequent commands need to be issued to quiet WLAN transmissions.

FIG. 3 represents a multi-mode device 300 that includes a GSM mobile station, a WLAN, and a Bluetooth subsystem. Such embodiment of the present invention quiets the WLAN transmitter whenever the GSM or Bluetooth receivers are scheduled to receive time-slotted data transmission bursts. A portion of the WLAN subsystem comprises a WLAN media access controller (MAC) 302, a WLAN baseband transmitter 304, a WLAN baseband receiver 306, a WLAN radio chip 308, and a corresponding WLAN antenna 310 that operate in the 2.4-GHz or 5-GHz bands. For example, IEEE-802.11a/b/g.

A WLAN-TX scheduler 312 can issue a WLAN transmit power control signal 314 that will reduce or turn-off RF power output from the WLAN antenna 310 whenever the BlueTooth or GSM need to receive data transmissions. A MAC-stall signal 316 causes the MAC 302 to stop sending data for transmission, and to store up the data for later transmission. The WLAN-TX scheduler 312 will issue both the WLAN transmit power control signal 314 and MAC-stall signal 316 whenever it receives a GSM-RX request 318. A GSM-RX waveform 319 represents the pulse-like nature of this request and corresponds to signal 220 in FIG. 2.

The GSM MS comprises a keypad/display 320, a subscriber identity module (SIM) card 322, a control processor 324, a Layer-1 radio link control 326, a digital signal processor 328, a GSM radio chip (RF) 330, and a GSM antenna 332 that operates in the 800-MHz, 900-MHz, 1.8-GHz, and/or 1.9-GHz radio bands.

A BlueTooth request 334, with waveform 335, issued to the WLAN-TX scheduler 312 will quiet WLAN transmissions whenever a Bluetooth (BT) subsystem 336 needs to listen to received data from its BT antenna 338 operating in the 2.40-2.48 GHz radio bands.

The signaling protocol in a typical GSM mobile device is structured into three general layers. Layer-1 326 is a physical layer (PHY), which uses the channel structures over the air interface. Layer-2 is a data link layer. Layer-3 of the GSM signaling protocol is divided into three sublayers, radio resources (RRM), mobility (MM), and connection (CM) management. RRM controls the setup, maintenance, and termination of radio and fixed channels, including handovers. MM manages the location updating and registration procedures, as well as security and authentication. CM handles general call control, similar to CCITT Recommendation Q.931, and manages supplementary services and the short message service. Control software in Layer-3 is responsible for all control functions, such as call setup, mobility tracking, and handover activity. A man machine interface (MMI) and subscriber ID module (SIM) operations are also managed. Layer-2 is responsible for control-message flow control and retransmission. Layer-1 manages the airlink and controls the RF hardware in response to network messages and airlink conditions. All audio functions are handled by this layer in support of voice traffic.

GSM receiver sensitivity is generally governed by the noise figure of the front-end low-noise amplifier (LNA). Sensitivity is the ability of the receiver to decode a signal with a low signal-to-noise ratio (SNR), which can also be translated as a maximum acceptable BER at a given level. Under static conditions BER must be less than 2.44% at a signal input level of −102 dBm.

The SNR can be degraded by spurious signal 114. De-sensitization can occur on particular channels, due to interfering signals generated by the phone itself. These signals are usually harmonics of on-board clocks. For example, channel-5 (936 MHz) and channel-70 (949 MHz) correspond to the seventy-second and seventy-third harmonics of the 13-MHz reference clock used in a GSM mobile phone and are likely to be desensitized. Careful routing of the 13-MHz reference and power supply decoupling can help minimize the source of interference and improve receiver sensitivity on these channels.

In operation, a frequency list included in SIM card 322 is checked. The bit stream patterns on these frequencies are inspected for the unique data markers belonging to a BCCH. Every GSM frequency carries set up information, so it's a channel within the data stream that's important to find, not a specific radio frequency.

The base station BCCH continuously sends out identifying information about the local cell, e.g., its network identity, which wireless carrier owns it, the area code for the current location, whether frequency hopping is used, and information on surrounding cells to let the base station know a mobile is activated and wants service. The BCCH is a channel within the bit stream carried by any of the frequencies in a cell.

The GSM radio checks for a broadcast control channel (BCCH) by listening. The mobile receiver first checks for a signal from any base station within range. The mobile acts like a scanning radio, going through each BCCH frequency on its list, one by one, testing reception as it goes. It measures the received level for each channel. The GSM system, decides after this test which cell site should take the call, e.g., the cell site delivering the highest signal strength to the mobile. Once locked to the BCCH, the mobile monitors the ongoing data stream from the base station looking for a frequency control burst or frequency control channel burst (FCCB) of 142-bits. The distinctive burst is used to signal that synchronization bits will follow, so the mobile can synch up with the cellular system to make a wireless connection. And once that is done, mobile and base station can start their communication.

Data transmitted in bursts within the time slots. The transmission bit rate is 271-kb/s (bit period 3.79 microseconds). To allow for time alignment errors, time dispersion, etc., the data burst is slightly shorter than the time slot, 148 out of the 156.25 bit periods available within a time slot. The burst is the transmission quantum of GSM. Its transmission takes place during a time window lasting (576+ 12/13) microseconds, i.e. (156+¼) bit duration. A normal burst contains two packets of 58 bits surrounding a training sequence of 26-bits. The 26-bit training sequence has a predetermined pattern that is compared with the received pattern in order to reconstruct the rest of the original signal for multipath equalization.

The TDMA time-frames from each mobile station must be synchronously received by the BTS. And such synchronization is enable by using timing advance (TA). The degree of synchronization is measured by the BTS on the uplink, by checking the position of the training sequence. This training sequence is mandatory in all frames transmitted from the MS. From these measurements, the BTS can calculate the TA and send it back to the MS in the first downlink transmission. The MS uses TA to calculate when to send each frame so that they synchronously arrive at the BTS. The values of TA are continuously calculated and transmitted to the MS during the lifetime of a connection.

GSM radio transmission is accomplished by sending data in bursts. The burst is the physical content of a time slot. Each burst consists of 148-bits of 3.69 msec each. Between the bursts there is a guard period of 30.5 msec to distinguish the consecutive bursts. Hence, each time slot interval has a fixed length of 156.25 bits or 15/26 ms. The actual burst varies in length, depending on the type of burst. The different parts in a burst have special functions. The number of bits used for a particular function may vary with the type of burst.

A fixed bit pattern, training sequence code (TSC) is predefined for both the MS and the BTS. It is used to train the MS in predicting and correcting the signal distortions in the demodulation process that are due to Doppler and multipath effects. The TSC has a 26, 41 or 64 bit pattern. The encrypted bits represent the useful bits serving for speech, data transmission, or signaling. The tail bits (TB) at the beginning flag the start of a burst. The tail bits at the end define the end of a burst. The guard period (GP) between to consecutive bursts is necessary for switching the transmitter on/off, and timing advance. The transmitted amplitude is ramped up from zero to a constant value over the useful period of a burst and then ramped down to zero again. This is always required for the MS, and the BTS may do so if the adjacent burst is not emitted. Being able to switch off helps reduce interference to other RF channels.

The time division multiplexing scheme used on the radio path, the BTS receives signals from different mobile stations very close to each other. However, when a mobile station is far from the BTS, the BTS must deal with the propagation delay. It is essential that the burst received at the BTS fits correctly into the time slot. Otherwise, the bursts from the mobile stations using adjacent time slots could overlap, resulting in a poor transmission or even in a loss of communication.

In order to solve the problem of the propagation delay, a compensation mechanism is necessary in the mobile station. The mobile station is able to advance its transmission time by a time known as the timing advance.

Time alignment is the process of transmitting early the bursts to the BTS to compensate for propagation delay. Once a connection has been established, the BTS continuously measures the time offset between its own burst schedule and the reception schedule of the mobile station burst. Based on these measurements, the BTS is able to provide the mobile station with the required timing advance via the SACCH. Note that the timing advance is derived from the distance measurement which is also used in the handover process. The BTS sends to each mobile station a timing advance parameter according to the perceived timing advance. Each mobile station advances its timing by this amount, with the result that signals from different mobile stations arriving at the BTS are compensated for propagation delay.

The airlink requires management, and is handled by the Layer-1 protocol. There are two basic categories of Layer-1 operation, bit manipulation and airlink surveillance. Bit manipulation operations are handled by the DSP. These include data/voice encoding, interleaving, burst building/transmission, filtering, and signal equalization. Airlink surveillance is managed by the Layer-1 with help from the Layer-3 and is responsible for cell selection, channel synchronization, timing and power adjustments, surrounding cell monitoring, and cell handovers.

The four basic parts of a Bluetooth system are a radio frequency (RF) unit, a baseband or link control unit, link management software, and the supporting application software. The Bluetooth radio is a short-distance, low-power radio operating in the unlicensed spectrum of 2.4-gigahertz (GHz). The radio uses a nominal antenna power of O-dBm (1-mW) and has a range of 10 meters. Optionally, a range of 100 meters may be achieved by using an antenna power of 20-dBm (100-mW). Data is transmitted at a maximum rate of one megabit per second. However, communication protocol overhead limits the practical data rate to about 721-Kbps.

Bluetooth uses spectrum spreading, the transmission hops among seventy-nine different frequencies between 2.402-GHz and 2.480-GHz at nominal rate of 1600-hops/s. Spectrum spreading minimizes interference from other devices in the 2.4-GHz band, such as microwave ovens and other wireless networks. If a transmission encounters interference, it waits 1/1600th of a second (625-μsec) for the next frequency hop and retransmits on a new frequency. Frequency hopping also provides data security because two packets of data are never sent consecutively over the same frequency, and the changing frequencies are pseudo-random. The Link Controller handles all the Bluetooth baseband functions, e.g., encoding voice and data packets, error correction, slot delimitation, frequency hopping, radio interface, data encryption, and link authentication. It also executes the Link Management software.

FIG. 4 represents a method embodiment of the present invention, and is referred to here by the general reference numeral 400. The method 400 comprises a step 402 that allows a GSM mobile phone to run normally. A collocated WLAN has its transmitter controlled so that its transmissions do not interfere with the periodic timeslot bursts that the GSM receiver needs to tune. These needs change depending on whether the GSM mobile phone is off, sleeping, making a call, engaged in a call, text messaging, or ending a call. A step 404 collects all theses reception needs and determines if the WLAN transmitter needs to be quieted, and in particular schedules the exact periods of time for quieting. If the GSM RX doers not need to receive BTS data, a step 406 enables the WLAN MAC to forward TX data, and a step 408 allows the WLAN radio transmitter to be powered up. Otherwise, a step 410 stalls the WLAN MAC from forwarding TX data, and a step 412 causes the WLAN radio transmitter to be powered down.

Although particular embodiments of the present invention have been described and illustrated, such is not intended to limit the invention. Modifications and changes will no doubt become apparent to those skilled in the art, and it is intended that the invention only be limited by the scope of the appended claims.

1. A multi-mode communications device, comprising:
a GSM subsystem including a GSM receiver;
a WLAN subsystem collocated with the GSM subsystem, and including a WLAN transmitter;
a scheduler connected to receive GSM timeslot information from said GSM receiver, and to quiet said WLAN transmitter during times specific GSM bursts could be received from a GSM base-station.

2. The multi-mode communications device of claim 1, further comprising:
a Bluetooth (BT) subsystem including a BT receiver;
wherein, the scheduler is further connected to receive BT timeslot information from said BT receiver, and to quiet said WLAN transmitter during times specific BT bursts are to be received from a local BT transmitter.

3. The multi-mode communications device of claim 1, wherein a specialized filter between said WLAN transmitter and said GSM receiver is not required and therefore not included in order to reduce manufacturing costs and reduce overall bulk.

4. The multi-mode communications device of claim 1, further comprising:
a layer-1 radio link controller included in the GSM subsystem and providing for the generation of a WLAN quieting control signal; and
a WLAN transmit scheduler connected to respond to said WLAN quieting control signal by stalling a media access controller and de-powering a radio output transmitter disposed in said WLAN subsystem.

5. A multi-mode WLAN-GSM communications device comprising a WLAN transmitter that stalls its transmit data and depowers its radio transmitter whenever a collocated GSM receiver signals it needs to receive a GSM base-station transmission, or a collocated Bluetooth (BT) receiver signals it needs to receive a BT transmission.

6. A method for operating and therein reducing the manufacturing costs of a multi-mode communications device, comprising:
operating a GSM subsystem normally;
detecting when a GSM receiver in said GSM subsystem is scheduled to receive a burst transmission from a GSM base-station;
stopping a collocated WLAN transmitter from operating during time periods said GSM receiver is scheduled to receive a burst transmission from said GSM base-station.

7. The method of claim 6, further comprising:
stopping the collocated WLAN transmitter from operating by stalling an associated media access controller (MAC) and reducing the radio output power.

8. The method of claim 6, further comprising:
detecting when a Bluetooth (BT) receiver in a collocated BT subsystem is scheduled to receive a burst transmission from a local BT transmitter
stopping a collocated WLAN transmitter from operating during time periods said BT receiver is scheduled to receive a burst transmission from said GSM base-station.

9. An improved multi-mode communications device, comprising a WLAN subsystem including a WLAN transmitter that can desensitize and interfere with collocated TDMA receivers, and characterized by:
a scheduler connected to receive receiver timeslot information from at least one collocated TDMA receiver, and to quiet said WLAN transmitter during times specific TDMA bursts must be received for normal operation;
wherein a specialized filter between said WLAN transmitter and said collocated TDMA receivers is not required and therefore not included in order to reduce manufacturing costs and reduce overall bulk.
